(19) United States
(12) Patent Application Publication
(10) Pub. No.: US 2006/0098358 A1
(43) Pub. Date: May 11, 2006

(54) Power supply configured to detect a power source

(76) Inventors: Peter M. Wambsganss, Bexbach (DE); Gareth J. Hackett, Bexbach (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/984,695

(22) Filed: Nov. 8, 2004

(51) Int. Cl. H02H 7/00

(52) U.S. Cl. 361/18

(57) ABSTRACT

Described herein is a power supply that is able to detect that the power supply is coupled to an in-seat power source of an aircraft, for example, and limit the available output power, thereby reducing the possibility of the in-seat power supply turning off. Thus, those electronic devices that include power management systems can adjust to the reduced available power by turning off unused devices or processes, such as battery charging, or reducing a processor power.

### RELATED APPLICATIONS

This application is related to, and hereby incorporates by reference the entire disclosure of each of the following commonly owned U.S. patent applications, each filed on even date herewith: (1) U.S. patent application Ser. No. ______, titled “Temperature Sensor for Power Supply,” (2) U.S. patent application Ser. No. ______, titled “Microcontroller Controlled Power Supply,” and (3) U.S. patent application Ser. No. ______, titled “Power Supply Connector.”

### BACKGROUND OF THE INVENTION

1. Field of the Invention

This invention relates to power supplies and, more specifically, to power supplies that automatically detect a power source to which they are connected.

2. Description of the Related Art

In order to power many electronic devices, such as household appliances, stereo components, and computing device, for example, those devices typically include a power-supply configured for coupling with an external power source. External power sources may include wall outlets, cigarette lighters in automobiles or other vehicles, and in seat power delivery systems in aircraft. Currently, the power sources each provide different levels of power and require different connectors for coupling with each power source. Thus, a separate power supply is required for powering an electronic device in both an automobile and an aircraft, for example. Accordingly, a power supply that couples both with a power source provided in an automobile and with a power source provided in an aircraft is desired.

As noted above, the in seat power delivery systems in airplanes currently deliver power at a different level than that delivered through cigarette lighters in vehicles. Thus, even if a single power supply is configured to couple with both an in-seat power supply and a cigarette lighter, the power supply may not operate properly and may provide an undesirable output signal due to the fact that the input source is unknown. Thus, a power supply that detects whether it is coupled with an in-seat power supply or with a vehicle, such as through a cigarette lighter in the vehicle, is desired.

Furthermore, typical in-seat power source allow a power supply to draw only a predetermined level of power, such as 75 W. If this predetermined level of power is exceeded, the in-seat power source will disable power output and the electronic device coupled to the power supply will only be able to operate from an alternative power source, if any. In order for the in-seat power source to re-enable power output, the power supply must be removed from the in-seat power source and reconnected to the in-seat power source. Thus, the use of the electronic device is interrupted and loss of data is possible.

Many electronic devices, such as computers, include power management software and/or hardware that monitor the available power and the power drawn by the electronic device and optimize certain characteristics of the electronic device according to this monitoring. For example, an electronic device with power management may reduce a brightness of a display device or a speed of a hard drive in response to a determination that the limitations of the power source are exceeded, or close to being exceeded. Thus, the electronic device may compensate for limits on the available power source. However, because an in-seat power source is disabled when a predetermined power level is exceed, thus requiring disconnection and reconnection in order to re-enable power delivery, power management features are not able to efficiently compensate for the limits on the in-seat power source. Thus, improved systems and methods for optimizing use of power management features in electronic-devices coupled to in-seat power sources are desired.

### SUMMARY OF THE INVENTION

In one embodiment, a power supply including a connector engaged with a receptacle of a power source comprises a sensor configured to sense one or more characteristics of the power source and a microprocessor coupled to the sensor, wherein the microprocessor receives an input from the sensor indicative of the sensed one or more characteristic. The microprocessor may be configured to determine a type of power source to which the connector is engaged in response to the received input.

In another embodiment, a method of adjusting a power level of a power supply comprises sensing one or more characteristics of a power source, determining a power level of the power supply in response to the sensed one or more characteristic, and limiting the power level of the power supply to the determined power level.

In another embodiment, a system of for adjusting a power level of a power supply, comprises a means for sensing one or more characteristics of a power source, a means for determining a power level of the power supply in response to the sensed one or more characteristic, and a means for limiting the power level of the power supply to the determined power level.

In another embodiment, a connector configured to engage with a receptacle of a power source comprises a sensor configured to sense one or more characteristics of the power source. The connector further comprises one or more output terminals coupled to a microprocessor, wherein the one or more terminals each transmit an electrical signal indicative of the sensed one or more characteristics and the microprocessor is configured to determine a type of power source to which the connector is engaged based on the one or more transmitted electrical signals.

### BRIEF DESCRIPTION OF THE DRAWINGS

These and other objects and features of the invention will become more apparent from the following description and appended claims taken in conjunction with the following drawings, wherein like reference numbers indicate identical or functionally similar elements.

FIG. 1 is a block diagram of a power supply coupled to an electronic device and to a power source via a connector.

FIG. 2 is a perspective view of an exemplary power supply including a cigarette lighter connector and an in-seat connector.

FIG. 3 is an electrical schematic of an exemplary power supply, connector, air receptacle, and vehicle receptacle.

FIG. 4A is a diagram of an exemplary air receptacle including four terminals, labeled with numbers 1-4.

FIG. 4B is a schematic of the air connector of FIG. 4A.

FIG. 5 is a diagram of an exemplary air receptacle including three terminals, labeled with numbers 1-3.

FIG. 6 is a diagram of an exemplary vehicle receptacle including two terminals, labeled with numbers 1 and 2.

### DETAILED DESCRIPTION OF THE PREFERRED EMBODIMENT

The following is a detailed description of embodiments of the invention. However, the invention can be embodied in a multitude of different ways as defined by the claims. The invention is more general than the embodiments that are explicitly described, and accordingly, is not limited by the specific embodiments.

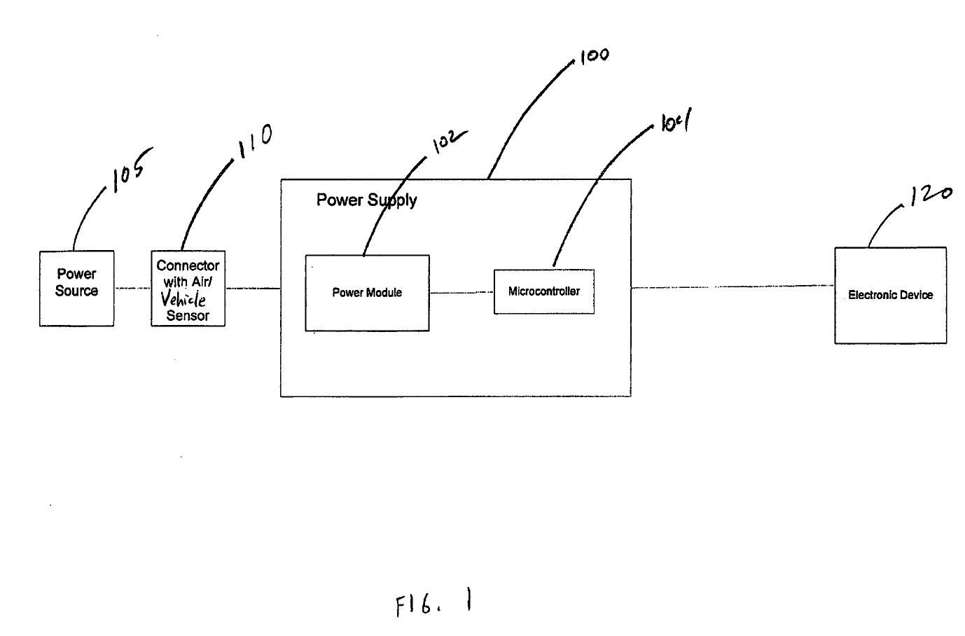

FIG. 1 is a block diagram of a power supply 100 coupled to an electronic device 120 and to a power source 105 via a connector 110. In the embodiment of FIG. 1, the electronic device 120 is any type of device that may be powered by an AC or DC power signal. The electronic device 120 may comprise, for example, a household appliance, a stereo component, a computing device, or any other electronic component. In one embodiment, the power source 105 comprises a receptacle of a vehicle cigarette lighter located in an automobile, water vehicle, or other recreational vehicle, for example, (referred to herein generally as a “vehicle receptacle”) configured to engage the connector 110, along with the power components coupled to the cigarette lighter, such as the battery and alternator, for example. In another embodiment, the power source 105 comprises an in seat power delivery source, including an in-seat receptacle (also referred to herein as a “air receptacle”) configured for engaging the connector 110 and the other power components that are coupled to the receptacle, such as generators and batteries. The connector 110, described in further detail below, may comprise a plug that is coupled to the power source 105 by inserting into either the in-seat or vehicle receptacle.

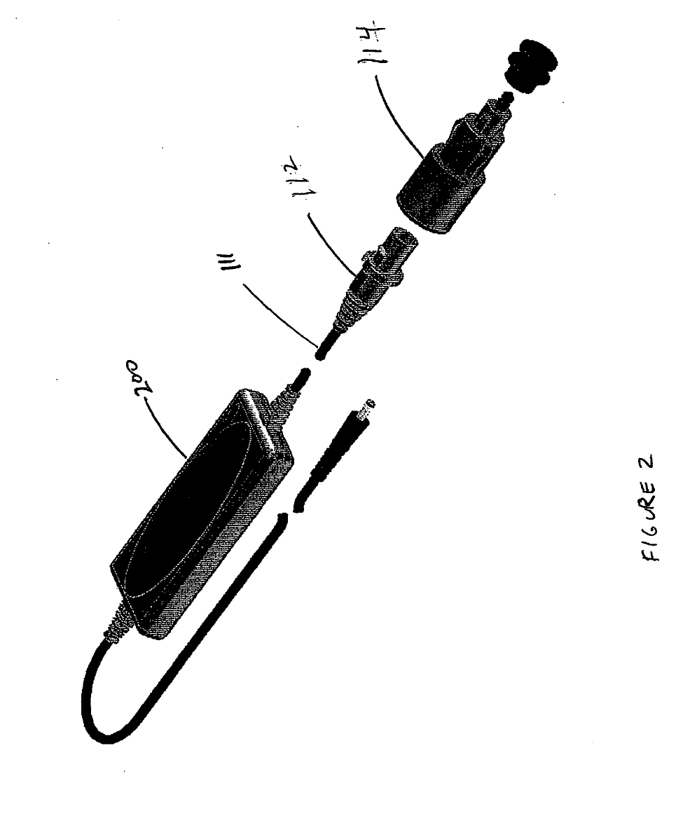

The connector 110 is mechanically shaped to be coupled with the power source 105. In one embodiment, the changeable connector 110 comprises a plug having one or more positive and negative leads exposed, wherein the plug may be inserted into a socket, or receptacle, of the power source 105. In one embodiment, the connector 110 is changeable, such that the connector 110 may be configured to couple with either an in-seat receptacle or a vehicle receptacle (See FIG. 2, below). In the embodiment of FIG. 1, the connector 110 includes an air/vehicle sensor that is configured to detect whether the connector 110 is coupled with a vehicle (e.g., a cigarette lighter receptacle) or an aircraft (e.g., an in-seat receptacle). The connector 110 may then communicate with the microcontroller 104, indicating the type of power source 105 to which the connector 110 is coupled. The microcontroller 104, in turn, may regulate the output power level from the power supply 100. As described above, in-seat power sources are typically configured to disable power output when a power supply attempts to draw power above a certain threshold, referred to herein as the “shut-off threshold.” This threshold in many current in-seat power delivery systems is 75 W, but could be any other level, such as 30 W, 50 W, 80 W, 100 W, or 120 W, for example. In an advantageous embodiment, the power supply 100 and connector 110 are configured to limit the power drawn from an in-seat power source to less than the shut-off threshold. Accordingly, the electronic device 120 will not be disconnected from the power source due to attempts to draw power in excess of the shut-off threshold. Because the power supply may be configured to limit the power drawn from the power source 105 without disabling power output to the electronic device, power management software and/or hardware in the electronic device 120 may compensate for this limited power level by switching off unused devices, disabling battery charging, or reducing the processor speed, for example.

As described in further detail below with respect to FIG. 3, the air/vehicle sensor in the connector 110 detects that the connector is coupled to an in-seat or a vehicle receptacle. Based on this determination, the power drawn from the power source may be adjusted. In one embodiment, if the air/vehicle sensor determines that the connector is coupled to an in-seat receptacle, the power drawn from the power source 105 is limited to a level that prevents the power source 105 from turning off. For example, the microcontroller 104 may be configured to set the maximum power drawn by an in-seat power source to a predetermined level, such as 65 W, for example. In another embodiment, the microcontroller 104 may be configured to set the maximum power drawn by an in-seat power source to a percentage of the shut-off threshold, such as 95%, 90%, or 80%, for example. Thus, if an in-seat power source has a shut-off threshold of 75 W and the microprocessor is configured to allow a maximum of 90% of the shut-off threshold to be drawn from the power source, 67.5 W would be available to the electronic device 120. Other limits may be set on the power drawn from an in-seat power source so that the power source is not disabled due to the power supply drawing power from the power source 105 in excess of the shut-off threshold. While the use of a shut-off threshold has been described above with respect to an in-seat power source, other power sources may also use shut-off thresholds. Thus, the systems and methods described herein for limiting a power level drawn from the power source 105 may also be used when coupled to those power sources.

In one embodiment, if the air/vehicle sensor determines that the connector is coupled to a vehicle receptacle, the microcontroller 104 does not limit the power drawn from the power source. Because vehicle power sources, such as in automobiles, typically do not have a shut-off threshold, limiting power drawn from a vehicle power source may not be necessary. However, if a shut-off threshold is present in a vehicle power source, the systems and methods described herein may be implemented to limit the power level drawn from the vehicle power source.

In the embodiment of FIG. 1, the power supply 100 comprises a power module 102 and a microcontroller 104. The power module 102 comprises the power delivery components that are configured to generate and supply the voltage to the electronic device 120. The microcontroller 104 is advantageously coupled to the power module 102 and is configured to control the output voltage level from the power module 102. In one embodiment, the coupling of the microcontroller 104 to the power module 102 is via one or more amplifiers, diodes, and other electronic components. Those of skill in the art will recognize that various components may be used in the power module 102 to transform and/or convert power from a power source. The systems and methods described herein expressly contemplate the use of any suitable components in the power module 102. For a more detailed description of the control of a power supply by a microcontroller, refer to commonly owned U.S. patent application Ser. No. ______, titled “Microprocessor Controlled Power Supply,” filed concurrently herewith, which is hereby incorporated by reference in its entirety.

FIG. 2 is a perspective view an exemplary power supply 200, including a cigarette lighter connector 114 (also referred to as a “vehicle connector 114”) and an in-seat connector 112 (also referred to herein as an “air connector 112”). As illustrated in FIG. 2, the power supply 200 may be connected to a vehicle power source by coupling the vehicle connector 114 with a vehicle receptacle. In the embodiment of FIG. 2, the air connector 112 is integrally connected with the power supply 200 via cable 111. However, the air connector 112 may be detachable from the cable 111 such that alternative connectors, such as a vehicle connector 114 may be directly coupled to the cable 111 or the power supply 200.

In the embodiment of FIG. 2, the vehicle connector 114 is configured to engage with the air connector 112 on a first end and with a vehicle receptacle on a second end. Thus, the power supply 200 is configured to provide power to electronic devices from either an air or vehicle power source. In one embodiment, the air/vehicle sensor described above with reference to FIG. 1 is located in the air connector 112. Thus, when the vehicle connector 114 is detached from the air connector 112, and the air connector 112 is engaged with an air receptacle, the air/vehicle sensor is able to detect that the power supply is coupled to an air power source and adjust the power level of the power supply 200 accordingly. If the power source 200 is then moved to an automobile, for example, the vehicle connector 114 may be coupled to the air connector 112 and to a vehicle receptacle and the air/vehicle sensor is able to detect that the power supply 200 is connected to a vehicle power source. The connectors illustrated in FIG. 2 are provided for ease of description and are not intended to limit the scope of possible connectors that may be used with the power supply 200. Those of skill in the art will recognize that the systems and methods described herein may be applied to various other power connectors and various configurations thereof.

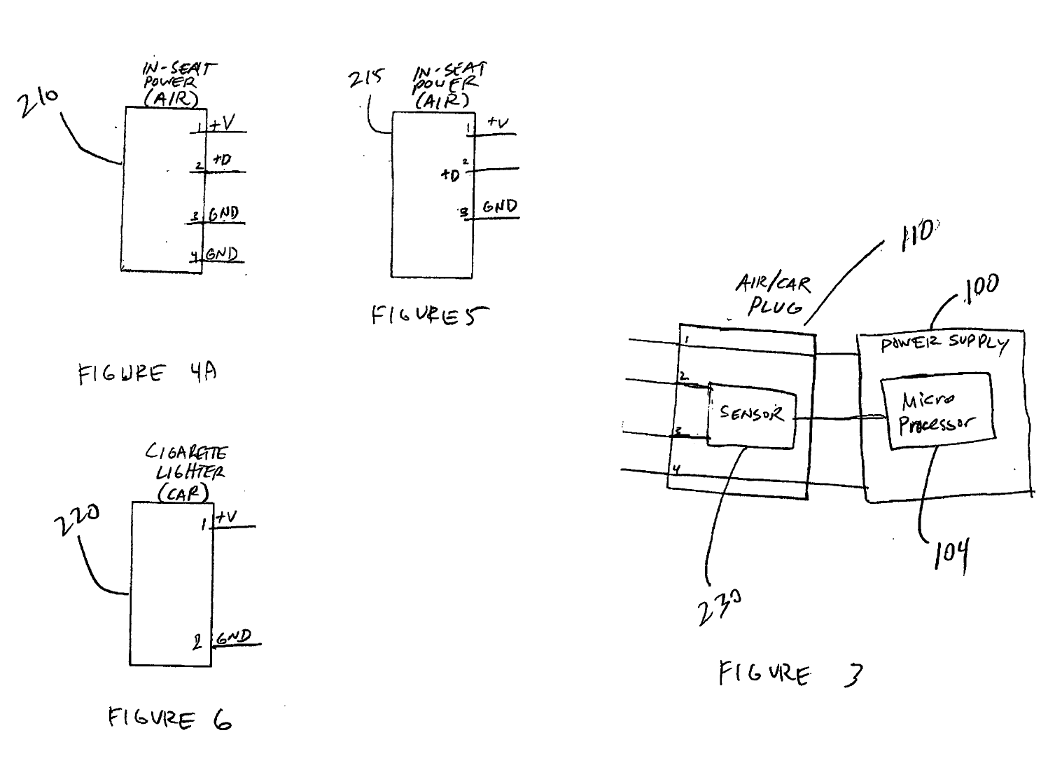

FIG. 3 is an electrical schematic of the exemplary power supply 100 and connector 110. In the embodiment of FIG. 3, the connector 110 may be coupled to either an air receptacle 210 or 215, or a vehicle receptacle 220 (FIGS. 4, 5, and 6). For example, in one embodiment, the connector 110 comprises both the air connector 112 and the vehicle connector 114 of FIG. 2, such as illustrated in FIG. 2, for example. In another embodiment, the connector 110 comprises multiple components that are changeable so that the connector 110 is mechanically sized to engage the selected air, vehicle, or other receptacle.

In the embodiment of FIG. 2, the connector 110 comprises a sensor 230 that is configured to detect one or more characteristics of the power source to which the connector 110 is coupled. In the embodiment of FIG. 3, the connector 110 includes four terminals, labeled with numbers 1-4, that may be connected to a power source. In other embodiments, however, more or less terminals may be coupled to a power source. For example, if the sensor 230 uses a reference signal, such as ground, the sensor 230 may use the reference signal for the power signal, rather than requiring a separate reference signal. Accordingly, the number of terminals may be reduced to three, for example.

In one embodiment, the sensor 230 comprises a voltage sensor that detects a voltage across pins 2 and 3 of the connector 110. As described in further detail below, by sensing a voltage across pins 2 and 3, the connector 110 can determine whether the connector 110 is coupled with an air receptacle or with a vehicle receptacle. In other embodiments, the sensor 230 detects one or more data values stored in a data element in the power source. For example, an air power source may include an EPROM containing one or more data values identifying the power source as an air power source.

FIG. 4A is a diagram of an exemplary air receptacle 210 including four terminals, labeled with numbers 1-4. The exemplary air receptacle 210 comprises a coupling mechanism configured to engage connector 110 so the terminals 1-4 of the air receptacle 210 are electronically coupled to terminals 1-4, respectively, of the connector 110. A first and a fourth terminal (labeled 1 and 4) of the exemplary air receptacle 210 provide a positive voltage and a reference voltage to the connector 110. Thus, power is delivered between pins 1 and 4 of the exemplary air receptacle 210. Terminals 2 and 3 of the air receptacle 210 are coupled to the sensor 230 and provide a signal, labeled “+D” in FIG. 4A, to the sensor indicating that the connector 110 is coupled to an air power source. In one embodiment, the +D signal on terminal 2 is a predetermined level, such as 5 volts, for example. Thus, the sensor 230 may detect a voltage difference of 5 volts between the +D signal on terminal 2 and the reference signal on terminal 3. This voltage difference may then be communicated to the microprocessor 104 of the power supply 100. In an advantageous embodiment, the microprocessor 104 is configured to recognize the voltage difference as indicative of a connection with an air receptacle. Accordingly, the microprocessor may then limit the power drawn from the air receptacle 210 according to the determined appropriate level in order to prevent reaching the shut-off threshold.

FIG. 4B is a schematic of the air connector 210. In one embodiment, the air receptacle 210 only provides power to the connector if terminals 2 and 3 are electronically coupled external to the air receptacle 210, such as by a component of the connector 110. Thus, the connector 110 may be configured to couple terminals 2 and 3 when the connector 110 is coupled to the air receptacle 210 so that the air power supply is activated and power is supplied to terminals 1 and 4 to provide an appropriate power level. As illustrated in FIG. 4B, a switch 410 must be closed in order for power to be delivered to terminal 1 of the receptacle 210. In one embodiment, the switch 410 is closed, and output power from the in-seat power source is available, when the output enable signal on terminal 2 is electrically connected to the output enable return signal on terminal 3 through a connection in the connector 110. As illustrated in FIG. 4B, the output enable signal on terminal 2 is coupled to a pull up resistor, having a value of 4 kΩ, for example, to an internal rail voltage, such as 5V. Thus, this rail voltage may be sensed by the connector 210 or power supply 100 in order to detect coupling with an air receptacle.

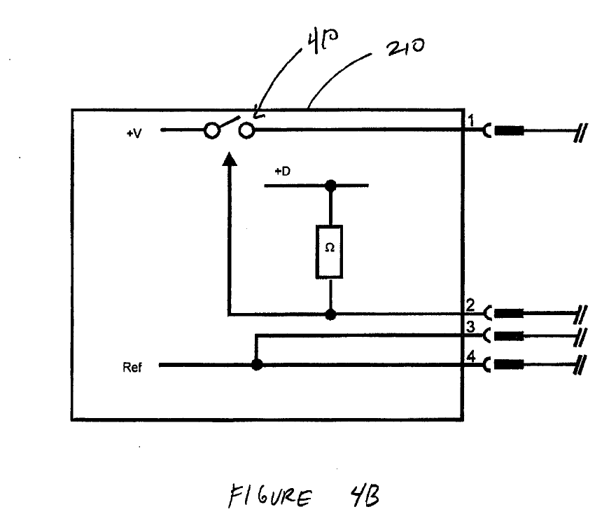

FIG. 5 is a diagram of an exemplary air receptacle 215 including three terminals, labeled with numbers 1-3. The exemplary air receptacle 215 comprises a coupling mechanism configured to engage connector 110 so the terminals 1-3 of the air receptacle 215 are electronically coupled to terminals 1-3, respectively, of the connector 110. In this embodiment, the reference signal provided on terminal 3 of the air receptacle 215 is used in combination with the +V signal on terminal 1 to provide a power signal to the power supply 100. In this embodiment, the reference signal on terminal 4 is also used as a reference signal to the sensor 230, if necessary. Thus, the sensor 230 coupled to the air receptacle 215 may detect a signal +D via a connection between terminal 2 and 3 of the air receptacle 215 and power may be delivered to the connector 110 via a connection between terminals 1 and 3 of the air receptacle 215.

In another embodiment, the line 2 of the air receptacles 210 and 215 may be coupled to a data element, such as a memory device, for example. In this embodiment, the sensor 230 reads one or more values from the data element and transmits these values to the microprocessor 104, which may then determine if the connector 110 is coupled to an air receptacle or a vehicle receptacle. For example, if the value ‘1’ is read from a data element, the sensor 230 may transmit this value to the microprocessor 104, which then determines that the connector 110 is coupled to an air receptacle. If the value read from the data element, however, is a zero or any other voltage, the microprocessor 104 may determine that the connector 110 is coupled to a vehicle receptacle. Those of skill in the art will recognize that various combinations of data may be stored in a data element to indicate either an air receptacle or vehicle receptacle. In addition, various data elements may be used in order to store data and various methods for reading this data may be implemented by one of skill in the art.

FIG. 6 is a diagram of an exemplary vehicle receptacle 220 including two terminals, labeled with numbers 1 and 2. The exemplary vehicle receptacle 220 comprises a coupling mechanism configured to engage connector 110 so that terminals 1 and 2 of the vehicle receptacle 220 are electronically coupled to terminals 1 and 4, respectively, of the connector 110. In the embodiment of FIG. 6, terminals 1 and 2 are used for power delivery to the connector 110. Because terminals 2 and 3 of the connector 110 are not couple to a terminal of the vehicle receptacle 220, the microprocessor 104 is configured to determine that when there is no signal provided to the sensor, the connector 110 is coupled to a vehicle receptacle. For example, the sensor 230 may detect either a voltage level between terminals 2 and 3 of the connector 110 or may attempt to read a data value on terminal 2 of the connector 110. However, this voltage level or data value will be floating or zero and the microprocessor 104 may be configured to determine that the connector 110 is coupled to a vehicle receptacle 220 when the input from the sensor is zero or floating. In contrast to the air receptacles, the vehicle receptacle 220 does not include enable pins. Accordingly, the vehicle receptacle 220 is always active, supplying a positive voltage to pin 1 and a reference voltage to pin 2.

The sensor 230 of the connector 110 may include any number of components that are capable of detecting one or more characteristics of a receptacle, such as an air or vehicle receptacle. As described above, in one embodiment, the sensor 230 is configured to provide an output to the power supply 100 indicating a voltage difference between input pins 2 and 3 of the connector 110. This output may then be interpreted by the microprocessor 104 to determine if the connector is coupled to an air receptacle or a vehicle receptacle 220. The power supply 100 may then limit the power drawn by the power supply according to the determined receptacle type. In one embodiment, if the sensor 230 detects a voltage difference of about 5 volts, the microprocessor 104 determines that the connector 110 is coupled to an air receptacle. If, however, the voltage sensor 230 detects no voltage difference between pins 2 and 3, the microprocessor determines that the connector 110 is coupled to a vehicle receptacle. Thus, because the power supply 100 is able to determine to which power supply the connector 110 is coupled, the power supply 100 is able to limit the power drawn by the electronic device 120.

Specific parts, shapes, materials, functions and modules have been set forth, herein. However, a skilled technologist will realize that there are many ways to fabricate the system of the present invention, and that there are many parts, components, modules or functions that may be substituted for those listed above. While the above detailed description has shown, described, and pointed out the fundamental novel features of the invention as applied to various embodiments, it will be understood that various omissions, substitutions, and changes in the form and details of the components illustrated may be made by those skilled in the art, without departing from the spirit or essential characteristics of the invention.

What is claimed is:

1. A power supply including a connector engaged with a receptacle of a power source, the power supply comprising:
a sensor configured to sense one or more characteristics of the power source;
and
a microprocessor coupled to the sensor, wherein the microprocessor receives an input from the sensor indicative of the sensed one or more characteristic and the microprocessor is configured to determine a type of power source to which the connector is engaged in response to the received input.

2. The power supply of claim 1, wherein the one or more characteristic comprises a voltage difference between two terminals of the receptacle.

3. The power supply of claim 2, wherein if the voltage difference is about 5 volts, the microprocessor determines that the connector is engaged with an air receptacle and the microprocessor limits the power drawn from the power source.

4. The power supply of claim 3, wherein the microprocessor limits the power drawn from the power source to a percentage of a shut-off threshold in response to determining that the connector is engaged with an air receptacle.

5. The power supply of claim 3, wherein the microprocessor limits the power drawn from the power source to about 65 Watts in response to determining that the connector is engaged with an air receptacle.

6. The power supply of claim 1, wherein the one or more characteristic comprises a data value stored in a data element coupled to the power source.

7. The power supply of claim 1, wherein the one or more characteristic comprises at least one of a current, a resistance, a capacitance, and an inductance.

8. The power supply of claim 1, wherein the connector comprises an air connector integrally connected to the power supply and configured to engage an air receptacle.

9. The power supply of claim 8, wherein the connector further comprises a vehicle connector configured to engage the air connector on a first end and to engage a vehicle receptacle on a second end.

10. A method of adjusting a power level of a power supply, the method comprising:
sensing one or more characteristics of a power source;
determining a power level of the power supply in response to the sensed one or more characteristic; and
limiting the power level of the power supply to the determined power level.

11. The method of claim 10, wherein the determined power level is a fraction of a power level of the power source.

12. The method of claim 10, wherein the determined power level is about 65 Watts if the one or more characteristics are indicative of an air power source.

13. The method of claim 10, wherein the determined power level is substantially equal to a power level of the power source if the one or more characteristics are indicative of a vehicle power source.

14. The power supply of claim 10, wherein the one or more characteristic comprises at least one of a voltage, a current, a resistance, a capacitance, an inductance, and a digital data bit.

15. A system for adjusting a power level of a power supply, the system comprising:
means for sensing one or more characteristics of a power source;
means for determining a power level of the power supply in response to the sensed one or more characteristic; and
means for limiting the power level of the power supply to the determined power level.

16. A connector configured to engage with a receptacle of a power source, the connector comprising:
a sensor configured to sense one or more characteristics of the power source;
and
one or more output terminals coupled to a microprocessor, wherein the one or more terminals each transmit an electrical signal indicative of the sensed one or more characteristics and the microprocessor is configured to determine a type of power source to which the connector is engaged based on the one or more transmitted electrical signals.
